(19) United States
(12) Patent Application Publication
(10) Pub. No.: US 2019/0066658 A1
(43) Pub. Date: Feb. 28, 2019

(54) METHOD FOR LEARNING CONVERSION MODEL AND APPARATUS FOR LEARNING CONVERSION MODEL

(71) Applicant: HITACHI, LTD., Tokyo (JP)

(72) Inventors: Takuya FUJIOKA, Tokyo (JP); Qinghua SUN, Tokyo (JP)

(73) Assignee: HITACHI, LTD., Tokyo (JP)

(21) Appl. No.: 16/051,555

(22) Filed: Aug. 1, 2018

(30) Foreign Application Priority Data
Aug. 28, 2017 (JP) 2017-163300

(51) Int. Cl. G10L 15/06; G10L 15/16; G10L 15/01; G06F 17/30

(52) U.S. Cl. CPC G10L 15/063; G06F 17/30755; G10L 15/01; G10L 15/16

(57) ABSTRACT

In information conversion, a subjective similarity with target information is increased. A method for learning a conversion model is disclosed and includes performing a conversion process of converting conversion source information to post conversion information using the conversion model; performing a first comparison process of comparing the post conversion information with target information to calculate a first distance; performing a similarity score estimation process of using an evaluation model to calculate a similarity score with the target information from the post conversion information; performing a second comparison process of calculating a second distance from the similarity score; and performing a conversion model learning process of learning the conversion model using the first distance and the second distance as evaluation indices.

### TECHNICAL FIELD

The present invention relates to a technique for converting a voice signal using a neural network.

### BACKGROUND ART

As a method for converting the quality of voice of a certain speaker to the quality of voice of another target speaker using a voice signal processing method, there is a technique called voice quality conversion. For example, Nonpatent Literature 1 discloses a technique for performing voice conversion using a neural network.

In addition, Patent Literature 1 discloses the idea of extracting characteristic amounts of linguistic characteristics related to pauses for each of multiple pause estimation results and using a score calculation model built based on relationships between subjective evaluation values of the naturalness of pauses and characteristic amounts of linguistic characteristics related to the pauses to calculate scores of the pause estimation results based on characteristic amounts of the pause estimation results.

### CITATION LIST

### Patent Literature

Patent Literature 1: Japanese Laid-open Patent Publication No. 2015-99251

### Nonpatent Literature

Nonpatent Literature 1: L. Sun et al., “Voice conversion using deep bidirectional long short-term memory based on recurrent neural networks,” Proc. of ICASSP, pp. 4869-4873, 2015.

### SUMMARY OF INVENTION

### Technical Problem

As a method for converting the quality of voice of a certain speaker to the quality of voice of another target speaker using a voice signal processing method, there is a technique called voice quality conversion. As the application of this technique, an operation of a service robot and an automated response of a call center are considered.

Traditionally, in the interaction of a service robot, after voice recognition is used to receive voice of another speaker and an appropriate response is estimated in the robot, a voice response is generated by voice synthesis. In this method, however, if the voice recognition is not successfully performed due to environmental noise or if it is hard to understand a question of the other speaker and the estimation of the appropriate response is not successfully performed, the interaction is not established. It is, therefore, considered that if the interaction is not established, an operator staying at a remote site receives voice spoken by the other speaker and responds by speaking to continue the interaction. In this case, by converting the voice spoken by the operator to the same voice quality as a voice response of the service robot, interaction that does not gives an uncomfortable feeling to the other speaker can be achieved upon switching from an automated voice response to an operator's voice response.

This manual operation can be achieved without voice quality conversion also in a configuration in which voice spoken by the operator is recognized by voice recognition and recognized details are synthesized with a voice quality of the service robot. In this configuration, however, it takes several seconds to reproduce the synthesized voice after the speaking by the operator. It is, therefore, difficult to achieve smooth communication. In addition, it is difficult to properly recognize details spoken by the operator and synthesize voice reliably representing its intention. It is, therefore, considered that a configuration in which voice quality conversion is used is effective.

In addition, in the automated response of the call center, voice recognition is performed on voice spoken by an inquiring person, and an interaction system and a voice synthesis system generate a voice response. However, if the automated response is not supported, it is expected that a response is performed by a human operator. It is considered that the inquiring person who uses this system potentially desires to make a conversation with a human operator rather than the automated response. In this case, if it is not possible to distinguish whether a response of the call center is an automated response or a response by a human operator, it is considered that the number of responses by human operators can be reduced. It is, therefore, considered that a configuration for converting voice spoken by an operator to the same voice quality as an automated voice response is effective.

As a method for performing voice quality conversion, Nonpatent Literature 1 and the like have been proposed. The concept of a voice quality converting apparatus is described with reference to FIG. 1.

As shown in FIG. 1, in order to generate a voice quality conversion model, a parameter of a voice quality conversion model 103 is a random value in an initial state. First, a voice database (conversion source speaker) 100 is input to the voice quality conversion model 103 in the initial state, and a dissimilarity between a voice database (after conversion) 102 output from the voice quality conversion model 103 and a voice database (conversion target speaker) 101 is calculated by a dissimilarity calculator 104. Then, the voice quality conversion model 103 is optimized by repeating the update of the parameter of the voice quality conversion model 103 so that the dissimilarity is reduced.

When new conversion source speaker's voice 105 is input to the optimized voice quality conversion model 103, voice 106 after conversion is obtained by converting voice qualities of the voice to voice of the target speaker. The new conversion source speakers' voice 105 is, for example, other voice that is not included in the voice database 100 of the conversion source speaker. As the voice quality conversion model 103, a technique using a deep neural network (DNN) is known, as described in Nonpatent Literature 1, for example.

A method for generating voice based on scores obtained in a subjective evaluation experiment performed in advance is also known. For example, according to Patent Literature 1, an appropriate pause of generated voice is estimated from relationships between subjective evaluation values of the naturalness of pause arrangement and linguistic characteristic amounts related to pauses.

As described above, the voice quality conversion model 103 is optimized so that a physical dissimilarity between the voice after the conversion and the target speaker's voice is minimized. There are, however, two problems with the voice quality conversion model optimization using only this minimization standard. The first problem is that this optimization is based on only an objective index and may not be necessarily performed so that subjective similarity between the voice after the conversion and the target speaker's voice is increased. The second problem is that the optimization of the voice quality conversion model is not performed based on a dissimilarity between the voice after the conversion and voice of a third-party speaker. In order to appropriately bring the voice after the conversion closer to the conversion target speaker's voice, it is considered that a standard for bringing the voice after the conversion closer to the conversion target speaker's voice and a standard for taking the voice after the conversion away from the voice of the third-party person are required.

An object of the present invention is to increase a similarity with target information in information conversion.

### Solution to Problem

According to an aspect of the present invention, a method for learning a conversion model includes performing a conversion process of converting conversion source information to post conversion information using the conversion model; performing a first comparison process of comparing the post conversion information with target information to calculate a first distance; performing a similarity score estimation process of using an evaluation model to calculate a similarity score with the target information from the post conversion information; performing a second comparison process of calculating a second distance from the similarity score; and performing a conversion model learning process of learning the conversion model using the first distance and the second distance as evaluation indices.

According to another aspect of the present invention, an apparatus for learning a conversion model includes a conversion model that converts conversion source information to post conversion information; a first distance calculator that compares the post conversion information with target information to calculate a first distance; a similarity calculator that uses an evaluation model to calculate a similarity score with the target information from the post conversion information; a second distance calculator that calculates a second distance from the similarity score; and a conversion model learning section that learns the conversion model using the first distance and the second distance as evaluation indices.

### Advantageous Effects of Invention

According to the present invention, a subjective similarity with target information can be increased in information conversion. Especially, the naturalness of voice after voice quality conversion and a similarity with a conversion target speaker can be improved.

### BRIEF DESCRIPTION OF DRAWINGS

FIG. 1 is a block diagram showing operations of a voice quality converting apparatus described in Nonpatent Literature 1.

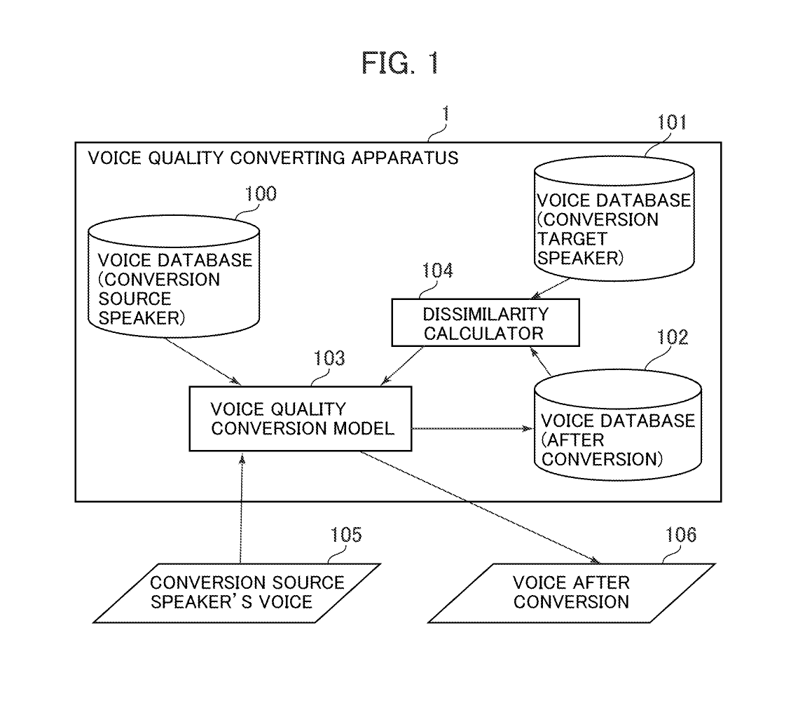

FIG. 2 is a conceptual diagram describing an entire process according to embodiments.

FIG. 3 is a block diagram showing a configuration of a voice quality converting apparatus according to a first embodiment.

FIG. 4 is a block diagram showing operations of the voice quality converting apparatus according to the first embodiment.

FIG. 5 is a flow diagram showing a procedure for using the voice quality converting apparatus according to the first embodiment.

FIG. 6 is a diagram of an experimental interface for calculating a score obtained from subjective similarity evaluation according to the first embodiment.

FIG. 7 is a flow diagram showing an experimental procedure for calculating a score obtained from the subjective similarity evaluation according to the first embodiment.

FIG. 8 is a table diagram showing the concept of data of similarity scores obtained in a subjective evaluation experiment.

FIG. 9 is a block diagram showing operations of a similarity calculator for similarities with target speaker's voice upon learning according to the first embodiment.

FIG. 10 is a block diagram showing operations of a voice quality conversion model learning section according to the first embodiment.

FIG. 11 is a block diagram showing operations of the similarity calculator for similarities with the target speaker's voice upon voice quality conversion model learning according to the first embodiment.

FIG. 12 is a table diagram showing an example of a data configuration of speaker labels.

### DESCRIPTION OF EMBODIMENTS

Hereinafter, embodiments are described using the accompanying drawings. The present invention, however, is not interpreted to be limited to details described in the following embodiments. It is understood by persons skilled in the art that specific configurations may be changed without departing from the spirit and gist of the present invention.

The same reference symbol is shared and used between different drawings by the same sections or sections having the same or similar functions in configurations according to the present invention described below, and a duplicated description is omitted in some cases.

If multiple elements that have the same or similar functions exist, different indices are added to the same reference sign in order to describe the elements. If it is not necessary to distinguish multiple elements, the elements are described without an index in some cases.

Expressions “first”, “second”, “third”, and the like in the present specification and the like are provided to identify constituent elements. The expressions do not necessarily limit the number, the order, or details of the constituent elements. In addition, a number that identifies a constituent element is used for each context. A number used in a single context does not necessarily indicate the same configuration in another context. In addition, a constituent element identified by a certain number is not inhibited from having a function of a constituent element identified by another number.

The positions, sizes, shapes, ranges, and the like of configurations shown in the drawings and the like may not indicate the actual positions, sizes, shapes, ranges, and the like in order to facilitate the understanding of the present invention. Thus, the present invention is not necessarily limited to the positions, sizes, shapes, ranges, and the like disclosed in the drawings and the like.

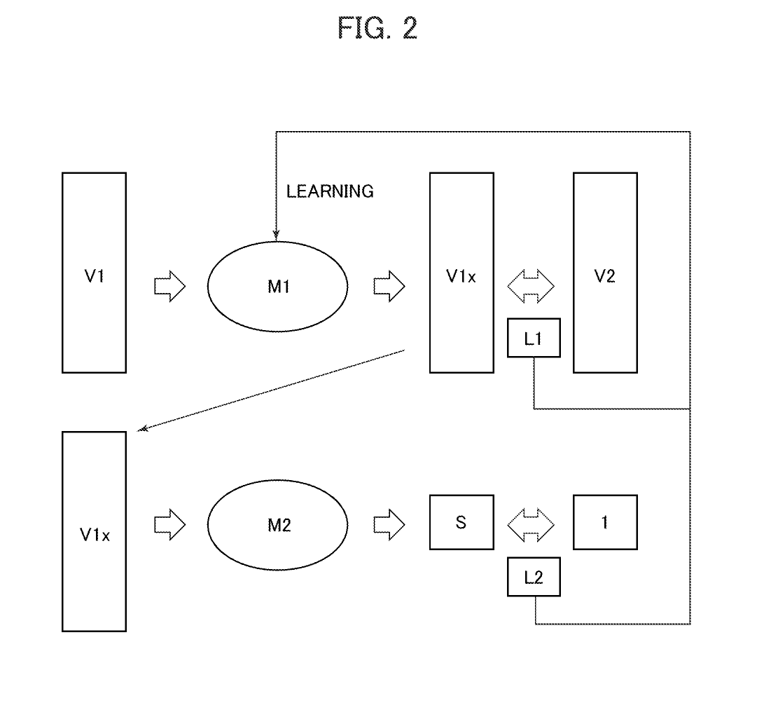

FIG. 2 is a diagram conceptually describing an overview of the embodiments described below. Conversion source speaker's voice V1 is converted to voice V1x after conversion by a voice quality conversion model M1. If the voice quality conversion model M1 is only learned and optimized so that a distance L1 between the voice V1x after the conversion and target speaker's voice V2 is reduced, the optimization is not necessarily performed so that a subjective similarity between the voice V1x after the conversion and the target speaker's voice V2 is increased.

In the embodiments, a model M2 is generated and implemented in a similarity calculator in order to estimate a subjective similarity score from the voice V1x after the conversion based on, for example, the evaluation of a subjective similarity experimentally calculated. A similarity score S (S is, for example, a value equal to or larger than 0 and equal to or smaller than 1, and 1 indicates matched) between the voice V1x after the conversion and the target speaker's voice V2 is estimated using the model M2, and a distance L2 that is the difference between the similarity score S and 1 is calculated. Then, the voice quality conversion model M1 is learned using the values L1 and L2. For example, L is defined as L1+cL2, and the voice quality conversion model M1 is learned so that L is minimized. In this case, c is a weight coefficient. The model M2 for calculating similarity scores can be learned using learning similarity score data obtained by subjectively determining similarities. In the embodiments, in order to generate the learning similarity score data, a subjective evaluation experiment is performed. Each of the models may be configured using a DNN or the like, and an existing method may be used as a method for learning the models.

As described above, in the embodiments, a cost function based on scores obtained in the subjective evaluation experiment is introduced, dissimilarities between post conversion voice obtained by referencing voice of multiple speakers and conversion target speaker's voice are introduced, and a voice quality conversion model is optimized.

### First Embodiment

In a first embodiment, in a manual operation of a service robot, an improvement of the naturalness of voice after voice quality conversion and an improvement of similarities with a target speaker are achieved using scores in which subjective similarities between the voice after the voice quality conversion and the conversion target speaker are reflected.

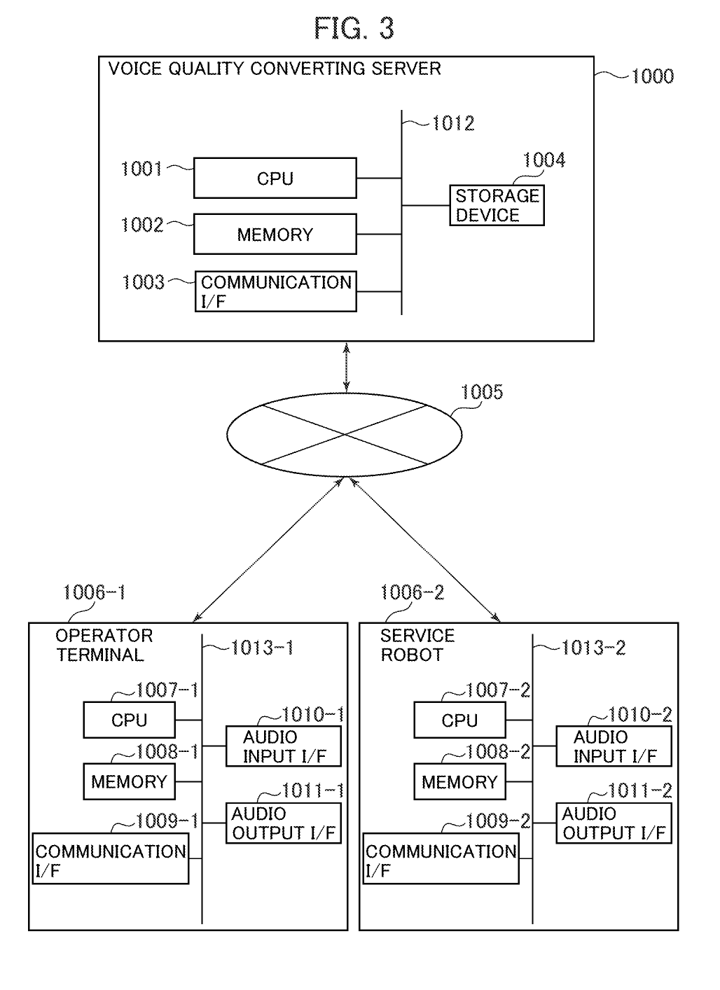

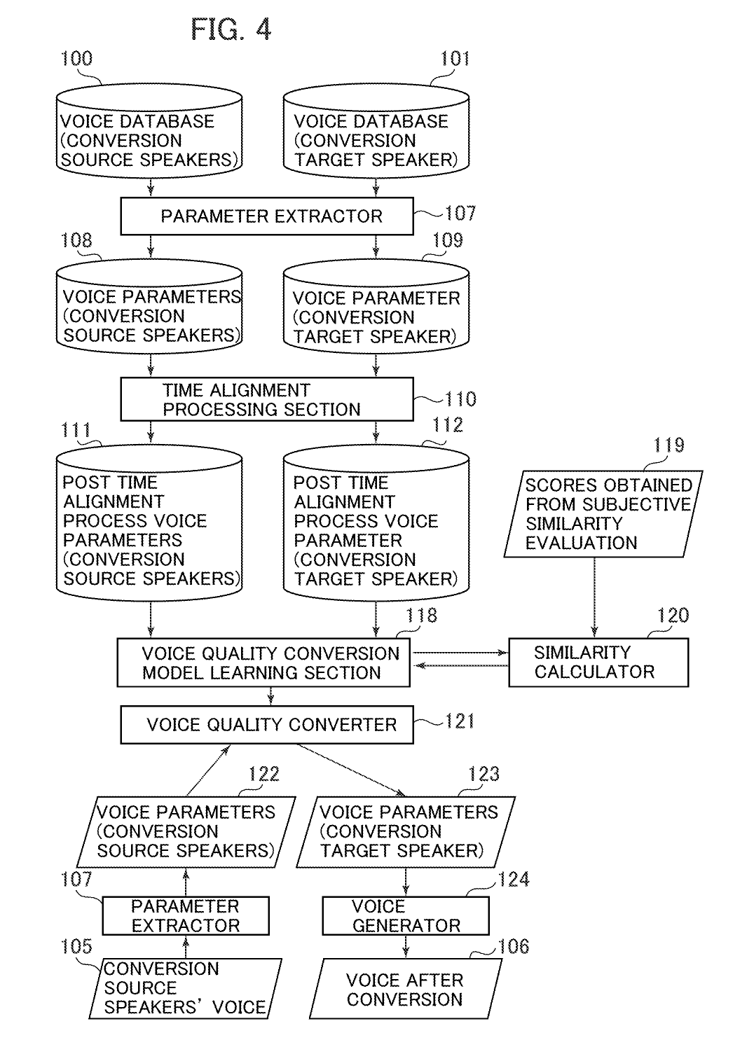

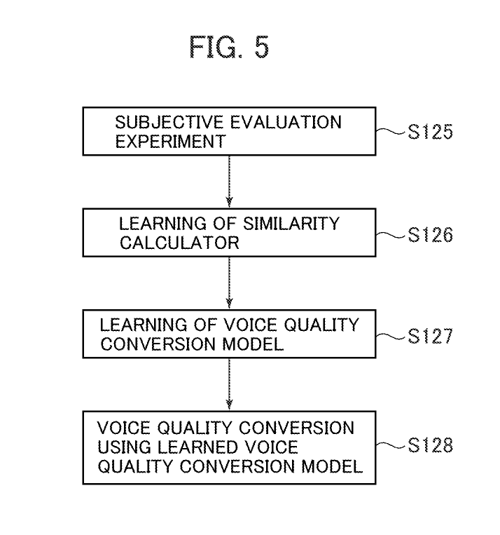

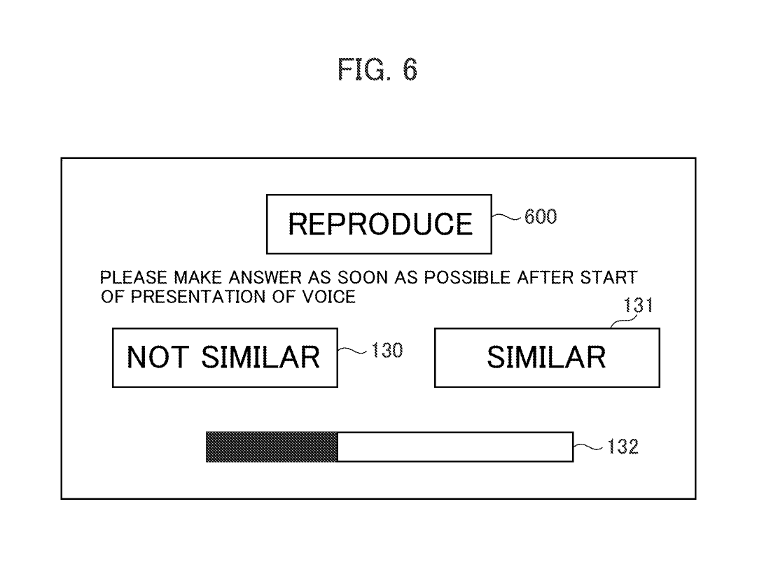

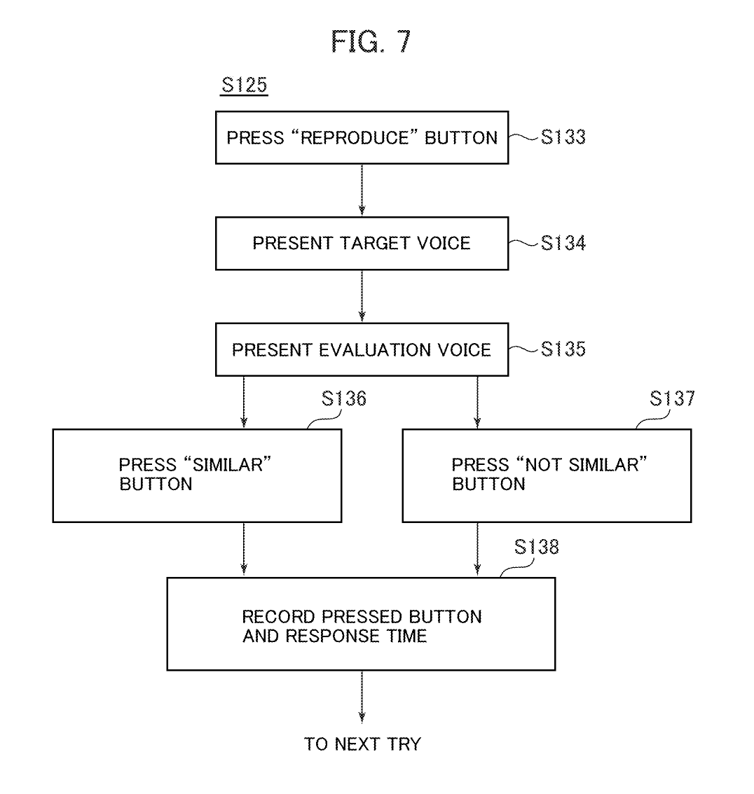

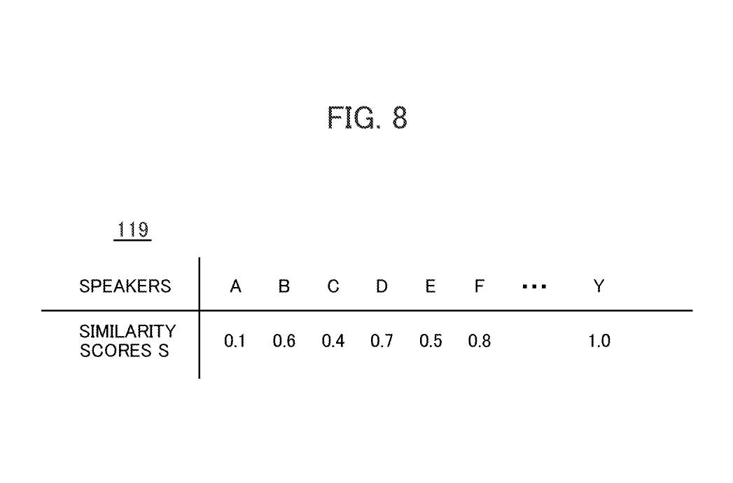

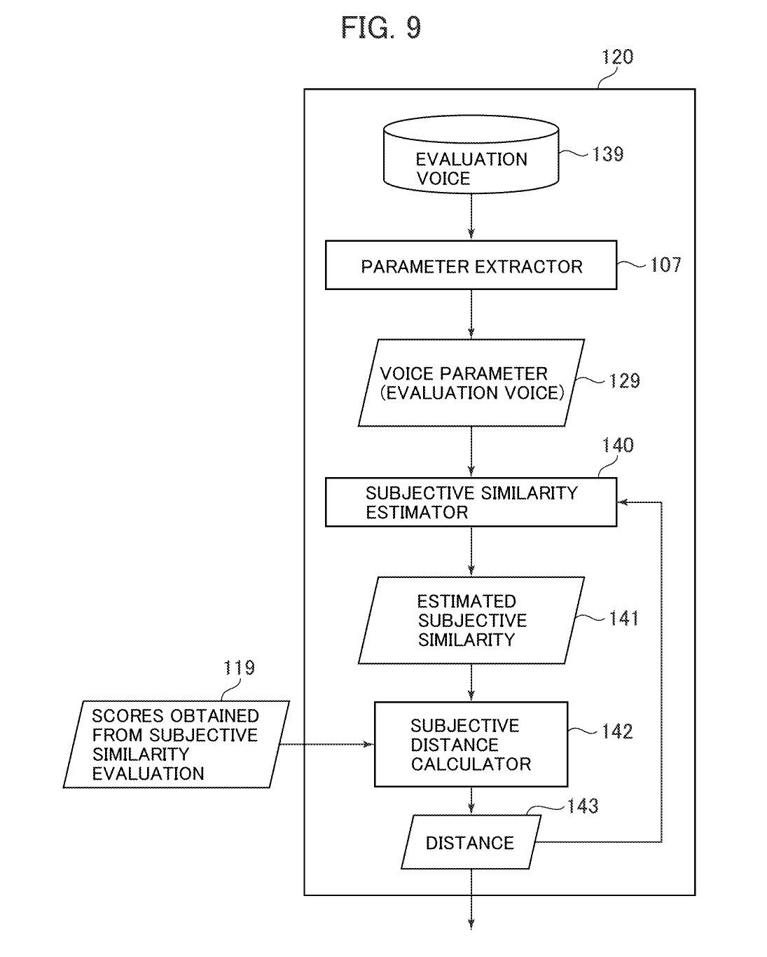

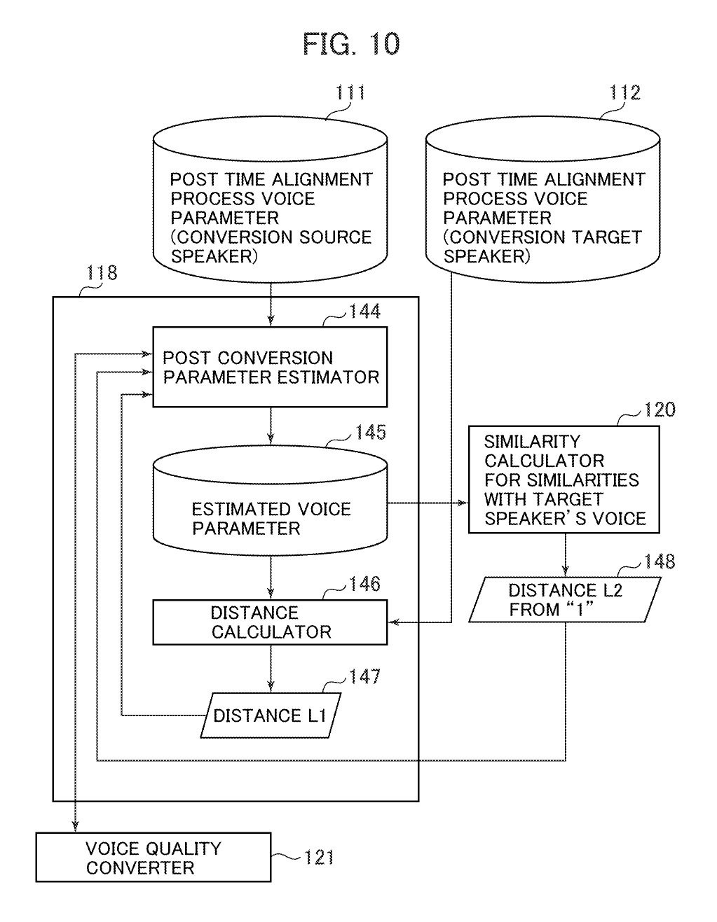

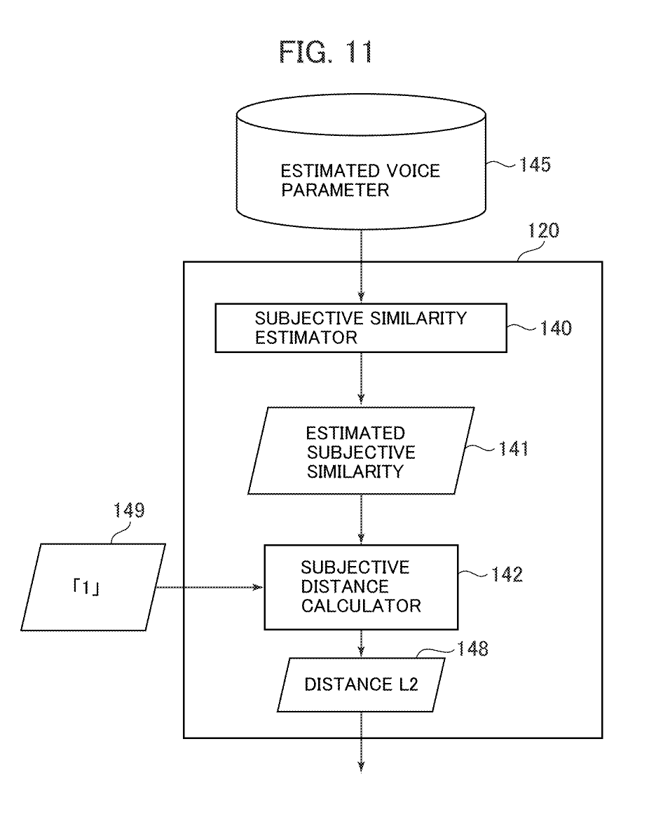

Hereinafter, configurations and operations of a voice quality converting apparatus according to the first embodiment are described with reference to FIGS. 3, 4, 5, 6, 7, 8, 9, and 10. FIG. 3 is a diagram showing a hardware configuration according to the present embodiment. FIG. 4 is a block diagram showing operations of the voice quality converting apparatus according to the present embodiment. FIG. 5 is a flow diagram showing a procedure for using the voice quality converting apparatus according to the present embodiment. FIG. 6 is a diagram of an experimental interface for calculating a score obtained from subjective similarity evaluation according to the present embodiment. FIG. 7 is a flow diagram showing an experimental procedure for calculating a score obtained from the subjective similarity evaluation according to the present embodiment. FIG. 8 is a table diagram showing the concept of data of similarity scores obtained in a subjective evaluation experiment. FIG. 9 is a block diagram showing operations of a similarity calculator for similarities with target speaker's voice upon learning according to the present embodiment. FIG. 10 is a block diagram showing operations of a voice quality conversion model learning section according to the present embodiment. FIG. 11 is a block diagram showing operations of the similarity calculator for similarities with the target speaker's voice upon voice quality conversion model learning according to the present embodiment.

FIG. 3 shows a hardware configuration diagram according to the present embodiment. The present embodiment assumes an operation of a service robot. A voice quality converting server 1000 includes a CPU 1001, a memory 1002, and a communication I/F 1003, while these constituent sections are connected to each other via a bus 1012. An operator terminal 1006-1 includes a CPU 1007-1, a memory 1008-1, a communication I/F 1009-1, an audio input I/F 1010-1, and an audio output I/F 1011-1, while these constituent sections are connected to each other via a bus 1013-1. A service robot 1006-2 includes a CPU 1007-2, a memory 1008-2, a communication I/F 1009-2, an audio input I/F 1010-2, and an audio output I/F 1011-2, while these constituent sections are connected to each other via a bus 1013-2. The voice quality converting server 1000, the operator terminal 1006-1, and the service robot 1006-2 are connected to a network 1005.

FIG. 4 shows a diagram related to operations in the memory 1002 within the voice quality converting server 1000 in a voice quality conversion process. In this drawing, a voice database (conversion source speakers), a voice database (conversion target speaker), a parameter extractor, a time alignment processing section, a voice quality conversion model learning section, the similarity calculator for similarities with the target speaker's voice, a voice quality converter, and a voice generator are included. FIG. 4 shows a process of learning and optimizing the voice quality conversion model and a process of converting conversion source speakers' voice by a voice quality converter 121 having the optimized voice quality conversion model implemented therein.

Voice spoken by the conversion source speakers is included in the voice database (conversion source speakers) 100, and voice spoken by the conversion target speaker is the voice database (conversion target speaker) 101. The spoken voice need to be the same phrase. The databases are referred to as parallel corpus.

The parameter extractor 107 extracts voice parameters from the voice database (conversion source speakers) 100 and the voice database (conversion target speaker) 101. In this case, it is assumed that the voice parameters are mel-cepstrum. The voice database (conversion source speaker) 100 and the voice database (conversion target speakers) 101 are input to the parameter extractor 107, and a voice database (conversion source speakers) 108 and a voice database (conversion target speaker) 109 are output from the parameter extractor 107. It is assumed that the multiple conversion source speakers exist. It is desirable that the voice spoken by the multiple conversion source speakers be included in the voice database (conversion source speakers) 100.

It is required that voice parameters to be input to a voice quality conversion model learning section 118 have been subjected to time alignment between the parallel corpus. Specifically, voice of the same phoneme needs to be spoken at the same time position.

Thus, the time alignment is performed by the time alignment processing section 110 between the parallel corpuses. As a specific method for performing the time alignment, there is dynamic programming matching (DP matching: Dynamic Programming). The voice database (conversion source speakers) 108 and the voice database (conversion target speaker) 109 are input to the time alignment processing section 110, and post time alignment process voice parameters (conversion source speakers) 111 and a post time alignment process voice parameter (conversion target speaker) 112 are output from the time alignment processing section 110.

The post time alignment process voice parameters (conversion source speakers) 111, the post time alignment process voice parameter (conversion target speaker) 112, and similarities output from the similarity calculator 120 for similarities with the target speaker's voice are input to the voice quality conversion model learning section 118, and the voice quality conversion model is optimized. The similarity calculator 120 uses similarity scores 119 obtained from the subjective similarity evaluation. Details thereof are described later.

After the learning of the voice quality conversion model, the voice quality conversion can be performed. The conversion source speakers' voice 105 is input to the parameter extractor 107 and converted to voice parameters (conversion source speakers) 122. The voice parameters (conversion source speakers) 122 are input to the voice quality converter 121, and voice parameters (voice after conversion) 123 are output from the voice quality converter 121. After that, the voice parameters (voice after conversion) 123 are input to the voice generator 124, and voice 106 after conversion is output from the voice generator 124.

FIG. 5 shows the flow of a process for the use of the voice quality converting apparatus according to the present embodiment. First, in order to obtain the subjective similarity scores 119 in the subjective similarity evaluation, a subjective evaluation experiment S125 is performed. Next, the learning S126 of the similarity calculator 120 for similarities with the target speaker's voice is performed using the subjective similarity scores 119 obtained in the subjective evaluation experiment S125. Then, the learning S127 of the voice quality conversion model is performed using subjective similarities (or distances) estimated by the learned similarity calculator 120 for similarities with the target speaker's voice. Lastly, the voice quality conversion S128 is performed using the learned voice quality conversion model.

The similarity calculator 120 is used to calculate similarities, output from the voice quality conversion model learning section 118, between voice with converted voice qualities and the target speaker's voice. In order to prepare data to be used to learn a similarity calculation model implemented in the similarity calculator 120, the subjective evaluation experiment S125 is performed. In the subjective evaluation experiment S125, voice of n speakers is prepared. It is desirable that voice of the voice database (conversion source speakers) 100 and the voice database (conversion target speaker) 101 be included in the n persons.

It is desirable that the voice of the n speakers be prepared by n types of voice quality conversion based on a single phrase of target voice of the voice database (conversion target speaker) 101. Thus, since prosody and intonation patterns of the speakers are the same as or similar to each other, these elements can prevent the subjective evaluation from being biased.

By performing the subjective evaluation experiment S125, similarity scores with the voice included in the voice database (conversion target speaker) 101 are added to the voice of the n speakers. 0 indicates the least similarity, 1 indicates the most similarity, and continuous values between 0 and 1 are added.

FIG. 6 shows an interface for the subjective evaluation experiment S125. First, an experiment participant presses a “reproduce” button 600. Then, a single phrase spoken by the conversion target speaker is presented. After predetermined time of, for example, approximately 1 second elapses, voice of a speaker randomly selected from the voice database of the n persons is presented. The voice of the former person is referred to as objective voice, while the voice of the latter person is referred to as evaluation voice. The voice is presented by a voice presenting device. As the voice presenting device, a headphone or a speaker is considered.

The experiment participant makes the determination of whether or not the evaluation voice is similar to the objective voice as soon as possible after the start of the presentation of the evaluation voice and makes an answer by pressing a “similar” button 130 or a “not similar” button 131. After time of approximately 1 second elapses after the answer, the next voice is presented. The progress of the subjective evaluation experiment is presented by a progress bar 132 to the experiment participant. As the experiment is progressed, a black portion becomes larger toward the right side. When the black portion reaches a right end, the black portion indicates the termination of the experiment.

In this case, a time period from the presentation of the evaluation voice to the pressing of a button by the experiment participant is measured. This time period is referred to as response time. The reaction time is used to convert the answer indicated by a binary value (similar or not similar) to a continuous value similarity score in a range between 0 and 1. The similarity score S is calculated according to the following equations.

S=min(1,1/tα)/2+0.5 (when the “similar” is pressed)

S=max(−1,−1/tα)/2+0.5 (when the “not similar” is pressed)

t is the response time, and α is an arbitrary constant number. It is interpreted that as the response time is shorter, the reliability of the answer by the button pressing is higher and that as the response time is longer, the reliability of the answer by the button pressing is lower. If S is between 0 and 1, another equation may be used instead.

FIG. 7 shows the flow of a single try of the subjective evaluation experiment S125. The pressing S133 of the “reproduce” button is performed by the experiment participant, the presentation S134 of the objective voice (voice to be converted) is performed, and the presentation S135 of the evaluation voice is performed. Then, the pressing S136 of the “similar” button or the pressing S137 of the “not similar” button is performed by the experiment participant immediately after the start of the reproduction of the evaluation voice. The recording S138 of the pressed button and the response time is performed, and the next try is performed.

By performing the aforementioned flow, similarity scores S that are between 0 and 1 are added to all presented evaluation voice. If multiple types of spoken voice are included as samples of evaluation voice of the same speaker, an average value of similarity scores for the multiple types of spoken voice may be treated as a similarity score S of the speaker.

FIG. 8 shows the concept of data of the similarity scores S119 obtained in the subjective evaluation experiment S125. As described above, it is desirable that voice of the conversion source speakers and voice of the conversion target speaker be included in the similarity scores. In FIG. 8, the conversion target speaker is Y, and a similarity of the evaluation voice spoken by the speaker Y is 1 (matched). The learning S126 of the similarity calculator 120 for similarities with the target speaker's voice is performed using the scores.

The similarity calculator 120 for similarities with the target speaker's voice uses a neural network to perform design. It is desirable that a unidirectional LSTM or bidirectional LSTM from which chronological information can be considered be used as an element of the neural network. In this case, the learning of the neural network, which estimates subjective similarities with the conversion target speaker for the evaluation voice used in the subjective evaluation experiment S125, is performed. According to the present embodiment, in order to increase subjective similarities, a larger amount of data can be used for the learning by using data of speakers other than the conversion source speakers and the conversion target speaker.

Functions of the similarity calculator 120 for similarities with the target speaker's voice upon the learning are described using FIG. 9. This embodiment assumes that evaluation voice of multiple speakers A to Y used to obtain the similarity scores shown in FIG. 8 is used as evaluation voice 139. It is assumed that the evaluation voice is stored in the voice database 100. In addition, it is assumed that the scores shown in FIG. 8 are stored as the similarity scores 119 obtained from the subjective similarity evaluation.

First, evaluation voice 139 of an initial speaker (for example, speaker A) is input to the parameter extractor 107, and a voice parameter (evaluation voice) 129 output therefrom is input to the subjective similarity estimator 140. The subjective similarity estimator 140 is configured using the neural network, for example. The subjective similarity estimator 140 outputs an estimated subjective similarity 141 between the evaluation voice of the speaker A and the voice of the target speaker (target speaker is Y in the example shown in FIG. 8). The estimated subjective similarity is input to the subjective distance calculator 142. Simultaneously, a corresponding similarity score 119 (similarity score “0.1” of the speaker A in the example shown in FIG. 8) obtained from the subjective similarity evaluation and shown in FIG. 8 is input to the subjective distance calculator 142.

The subjective distance calculator 142 calculates a distance 143 between the estimated subjective similarity 141 and the similarity score 119 obtained from the subjective similarity evaluation. This distance corresponds to the distance L2 shown in FIG. 2. As the distance, a square error distance is considered. The subjective distance calculator 142 outputs the calculated distance 143. The calculated distance 143 is input to the subjective similarity estimator 140, and an internal state of the subjective similarity estimator 140 is updated so that the distance 143 is reduced. This operation is repeated so that the distance 143 is sufficiently reduced. Although it is desirable that the number of samples of speakers of evaluation voice to be used for the learning be equal to or larger than a constant number, it is sufficient if the evaluation voice of the multiple speakers A to Y shown in FIG. 8 is sequentially used.

Functions of the voice quality model learning section 118 are described using FIG. 10. First, a post time alignment process voice parameter (conversion source speaker) 111 is input to a post conversion parameter estimator 144. The post conversion parameter estimator 144 is configured using the neural network, for example. A basic configuration of the post conversion parameter estimator 144 is the same as or similar to the voice quality converter 121 having the voice quality conversion model 103 implemented therein. The post conversion parameter estimator 144 outputs an estimated voice parameter 145. The estimated voice parameter 145 is input to a distance calculator 146.

Simultaneously, the post time alignment process voice parameter (conversion target speaker) 112 is input to the distance calculator 146. The distance calculator 146 calculates a distance 147 between the estimated voice parameter 145 and the post time alignment process voice parameter (conversion target speaker) 112. The distance 147 corresponds to the distance L1 shown in FIG. 2. As the distance, a square error distance is considered. The distance calculator 146 outputs the calculated distance 147.

In addition, the estimated voice parameter 145 is output to the similarity calculator 120 for similarities with the target speaker's voice. The similarity calculator 120 for similarities with the target speaker's voice outputs a distance 148 from “1”. The distance 148 corresponds to the distance L2 shown in FIG. 2. An operation of the similarity calculator 120 for similarities with the target speaker's voice upon the learning of the subjective similarity estimator 140 thereof described using FIG. 9 is different from an operation of the similarity calculator 120 for similarities with the target speaker's voice upon the learning of the voice quality conversion model. It is described later with reference to FIG. 11.

The calculated distance 147 (L1 shown in FIG. 2) and the distance 148 (L2 shown in FIG. 2) from “1” are input to the post conversion parameter estimator 144, and an internal state of the post conversion parameter estimator 144 is updated so that an evaluation parameter using both of the distance 147 and the distance 148 from “1” is reduced. As the evaluation parameter, L=L1+cL2 is used, as described above. The evaluation parameter, however, is not limited to this.

This operation is repeated until L is sufficiently reduced or until the distance 147 and the distance 148 from “1” are sufficiently reduced. Although it is desirable that the number of samples of conversion source speakers to be used for the learning be equal to or larger than the constant number, it is sufficient if the evaluation voice of the multiple speakers A to Y shown in FIG. 8 is sequentially used. The post conversion parameter estimator 144 after the sufficient reduction in L is implemented as the voice quality converter 121.

Functions of the similarity calculator 120 shown in FIG. 10 upon the learning of the voice quality conversion model are described using FIG. 11. First, the estimated voice parameter 145 is input to the subjective similarity estimator 140. The subjective similarity estimator 140 uses the neural network learned in the process described using FIG. 9 in advance. The subjective similarity estimator 140 outputs an estimated subjective similarity 141. The estimated subjective similarity is input to the subjective distance calculator 142. Simultaneously, a score “1” 149 indicating that the estimated voice parameter 145 matches the conversion target speaker's voice is input to the subjective distance calculator 142. Then, the subjective distance calculator 142 outputs the distance 148 between the estimated subjective similarity 141 and “1” 149. In this manner, the similarity calculator 120 transmits the distance 148 to the post conversion parameter estimator 144, and the post conversion parameter estimator 144 uses it for the learning.

According to the configuration described in the embodiment, the subjective evaluation of the similarities can be reflected in the learning of the voice quality conversion model.

### Second Embodiment

In the first embodiment, the similarities between the speakers and the target speaker's voice were calculated using the scores obtained from the subjective similarity evaluation. The similarities with the target speaker's voice can be calculated using speaker labels. A second embodiment describes this method.

Since configurations according to the second embodiment include common sections with those of the configurations described in the first embodiment, features that are different from the first embodiment are mainly pointed out with reference to FIGS. 4, 9, 10, and 11, and operations of a voice quality converting apparatus according to the second embodiment are described.

Blocks that indicate operations of the voice quality converting apparatus according to the second embodiment are described with reference to FIG. 4. As shown in FIG. 4, the voice quality converting apparatus according to the present embodiment includes a voice database (conversion source speakers) 100, a voice database (conversion target speaker) 101, a parameter estimator 107, a time alignment processing section 110, a voice quality conversion model learning section 118, a similarity calculator 120 for similarities with target speaker's voice, and a voice quality converter 121. Operations of the voice database (conversion source speakers) 100, the voice database (conversion target speaker) 101, the parameter estimator 107, the time alignment processing section 110, and the voice quality converter 121 are the same as or similar to the first embodiment. In the second embodiment, however, “speaker labels” are used instead of the similarity scores 119 obtained from the subjective similarity evaluation according to the first embodiment.

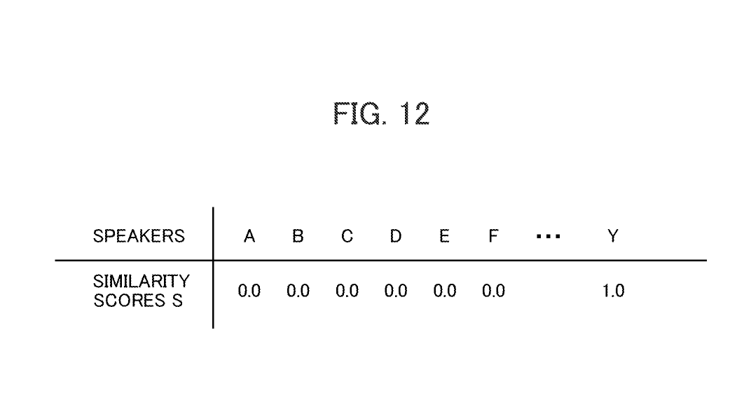

FIG. 12 is a table diagram showing an example of a data configuration of the speaker labels. Each of similarity scores of the speaker labels is a binary value of 1 or 0, compared with the similarity scores 119 shown in FIG. 8. 1 indicates matched and 0 indicates not matched. The target speaker Y is known and the speaker labels can be prepared without performing the subjective evaluation experiment S125 described in the first embodiment.

Blocks that indicate operations of the similarity calculator 120 for similarities with the target speaker's voice according to the present embodiment are described with reference to FIG. 9. First, the evaluation voice 139 is input to the parameter extractor 107, and the voice parameter (evaluation voice) 129 is output from the parameter extractor 107. In the second embodiment, a “speaker estimator” is used instead of the subjective similarity estimator 140 according to the first embodiment, and the voice parameter (evaluation voice) 129 is input to the speaker estimator. Voice of the voice database (conversion target speaker) 101 needs to be included in the evaluation voice. The speaker estimator is configured using the neural network. The speaker estimator outputs a speaker number that is an ID or number that identifies an estimated speaker. The estimated speaker number is input to the subjective distance calculator 142. Simultaneously, a speaker label shown in FIG. 12 is input to the subjective distance calculator 142, instead of the similarity score 119 obtained from the subjective similarity evaluation. The subjective distance calculator 142 calculates a distance 143 between the estimated speaker number and the speaker label. As the distance 143, a square error distance is considered. The subjective distance calculator 142 outputs the calculated distance 143. The calculated distance 143 is input to the speaker estimator, and an internal state of the speaker estimator is updated so that the distance 143 is reduced. This operation is repeated until the distance 143 is sufficiently reduced. Operations of the voice quality conversion model learning section according to the second embodiment can be described in a similar manner to the above description with reference to FIG. 10.

Blocks that indicate operations of the similarity calculator for similarities with the target speaker's voice upon the voice quality conversion model learning according to the present embodiment are described using FIG. 11. First, the estimated voice parameter 145 is input to the “speaker estimator” with which the subjective similarity estimator 140 has been replaced. The speaker estimator uses the neural network learned in advance. The speaker estimator outputs an estimated speaker number instead of the estimated subjective similarity 141. The speaker number is input to the subjective distance calculator 142. Simultaneously, “1” 149 that indicates a speaker label of the conversion target speaker's voice is input to the subjective distance calculator 142. Then, the subjective distance calculator 142 outputs a distance 143 between the estimated speaker number and “1”.

According to the second embodiment, it is possible to omit an experiment resulting in a cost factor and reflect pseudo subjective evaluation in the learning of the voice quality conversion model.

According to the aforementioned embodiments, subjective speaker similarity information can be reflected in an algorithm of the voice quality conversion.

The present invention is not limited to the embodiments and includes various modified examples. For example, a portion of a configuration according to a certain embodiment can be replaced with a configuration according to another embodiment. In addition, a configuration according to a certain embodiment can be added to a configuration according to another embodiment. Furthermore, a configuration according to each of the embodiments can be added to, removed from, or replaced with a portion of a configuration according to the other embodiment.

1. A method for learning a conversion model, comprising:
performing a conversion process of converting conversion source information to post conversion information using the conversion model;
performing a first comparison process of comparing the post conversion information with target information to calculate a first distance;
performing a similarity score estimation process of using an evaluation model to calculate a similarity score with the target information from the post conversion information;
performing a second comparison process of calculating a second distance from the similarity score; and
performing a conversion model learning process of learning the conversion model using the first distance and the second distance as evaluation indices.

2. The method for learning the conversion model according to claim 1, further comprising:
performing a subjective evaluation experiment to present the target information as objective information to a subject of the experiment, present multiple evaluation information items to the subject of the experiment, promote the subject of the experiment to input subjective evaluation of similarities between the objective information and the evaluation information items, and generate learning similarity score data; and
performing an evaluation model learning process of learning the evaluation model using the learning similarity score data.

3. The method for learning the conversion model according to claim 2,
wherein the multiple evaluation information items are multiple information items obtained by performing multiple types of conversion processes on the objective information.

4. The method for learning the conversion model according to claim 2,
wherein the multiple evaluation information items include the objective information and the conversion source information.

5. The method for learning the conversion model according to claim 2,
wherein the input of the subjective evaluation promotes the subject of the experiment to selectively input any of binary answers that is a positive opinion concerning the similarities or a negative opinion concerning the similarities.

6. The method for learning the conversion model according to claim 5,
wherein response time upon the input by the subject of the experiment is reflected in the learning similarity score data.

7. The method for learning the conversion model according to claim 6, further comprising:
converting the binary answers to scores that are continuous values in a range between 0 and 1.

8. The method for learning the conversion model according to claim 1, further comprising:
performing a subjective evaluation experiment to generate learning similarity score data in which a score indicating a similarity between the target information and the target information or indicating matched is 1 and in which a score indicating a similarity between the target information and information other than the target information or indicating not matched is 0; and
performing an evaluation model learning process of learning the evaluation model using the learning similarity score data.

9. The method for learning the conversion model according to claim 1, further comprising:
learning the conversion model in the conversion model conversion process so that L=L1+cL2 (where c is a weight coefficient) is minimized, where L1 is the first distance and L2 is the second distance.

10. The method for learning the conversion model according to claim 1, further comprising:
learning the conversion model in the conversion model conversion process so that both L1 and L2 are reduced, where L1 is the first distance and L2 is the second distance.

11. The method for learning the conversion model according to claim 1,
wherein the conversion source information is voice information, and the conversion process is a voice quality conversion process.

12. An apparatus for learning a conversion model, comprising:
a conversion model that converts conversion source information to post conversion information;
a first distance calculator that compares the post conversion information with target information to calculate a first distance;
a similarity calculator that uses an evaluation model to calculate a similarity score with the target information from the post conversion information;
a second distance calculator that calculates a second distance from the similarity score; and
a conversion model learning section that learns the conversion model using the first distance and the second distance as evaluation indices.
